(19) United States
(12) Patent Application Publication
(10) Pub. No.: US 2022/0374778 A1
(43) Pub. Date: Nov. 24, 2022

(54) Efficient Computation for Bayesian Optimization

(71) Applicant: Alibaba Singapore Holding Private Limited, Singapore (SG)

(72) Inventor: Yijun Huang, Bellevue, WA (US)

(73) Assignee: Alibaba Singapore Holding Private Limited

(21) Appl. No.: 17/326,054

(22) Filed: May 20, 2021

(51) Int. Cl. G06N 20/10; G06N 7/00

(52) U.S. Cl. CPC G06N 20/10; G06N 7/005

(57) ABSTRACT

Systems and methods implement a modular computing environment for Bayesian optimization, decoupling steps of Bayesian optimization across multiple modules; minimizing inter-module dependency; extending functionality of each module; and reusing computing resources and intermediate results within each module. Variable hyperparameterization may reduce computational costs of optimization iterations, while also averting overfitting and destabilization of the Gaussian kernel based on sparser observations of the objective function. Computational complexity of updating the Gaussian kernel may be reduced from the cube to the square of the set of sampled outputs, by deferring computing updates to each hyperparameter while the optimization iterations are ongoing. Furthermore, repeated allocation and release of memory, repeated writing of data in memory to non-volatile storage, and repeated reading of data in non-volatile storage to memory across multiple optimization iterations may be averted, thereby alleviating multiple categories of computing resources, including processing power, memory, storage, from excess performance load.

### BACKGROUND

Bayesian optimization (“BO”) is a frequently encountered computational problem in machine learning. Machine learning models are commonly trained by selecting an optimal set of hyperparameters which define behavior of the model. This selection process entails minimizing output of a loss function, which, in turn, entails performing optimization for a function ƒ(x) to find global and/or local maxima and/or minima across the space of the function ƒ(x). Many optimization processes are available for functions ƒ(x) where relationships between inputs and corresponding outputs may be determined based on knowledge of the function itself, and computing systems may readily evaluate an output for an input x with low computational overhead.

Bayesian optimization, in contrast, is applied to hyperparameter optimization problems wherein the function itself is not known, so that outputs for a function ƒ(x) cannot be evaluated without expressly computing the function for input x, and computational costs for evaluating an output for an input x tend to be high, such that repeated computations to evaluate multiple outputs cause computational costs to grow to untenable magnitudes. Such functions ƒ(x) are generally characterized as black-box functions, indicating that the function itself is not known; and furthermore characterized as expensive functions, indicating that computations of outputs of these functions are intensive in computational costs.

Bayesian optimization is developed on the basis that, for black-box functions which are also expensive functions, computational costs of hyperparameter optimization may be alleviated by evaluating an acquisition function in place of the expensive black-box function ƒ(x). An acquisition function should be one which is computationally inexpensive to evaluate, while approximating the behavior of the expensive black-box function ƒ(x) during optimization. However, since the computational cost of evaluating the expensive black-box function ƒ(x) cannot be fully alleviated, efficient Bayesian optimization remains a topic of active research and development.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a system architecture of a system configured to compute Bayesian optimization according to example embodiments of the present disclosure.

FIG. 2 illustrates Bayesian optimization computation modules according to example embodiments of the present disclosure.

FIGS. 3A and 3B illustrate an example computing system for implementing the processes and methods described herein for implementing Bayesian optimization.

FIG. 4 illustrates performance comparisons against the BoTorch programming library.

### DETAILED DESCRIPTION

Systems and methods discussed herein are directed to implementing efficient Bayesian optimization computation, and more specifically implementing a modular computing environment for Bayesian optimization, decoupling steps of Bayesian optimization across multiple modules; minimizing inter-module dependency; extending functionality of each module; and reusing computing resources among modules over iterative tasks.

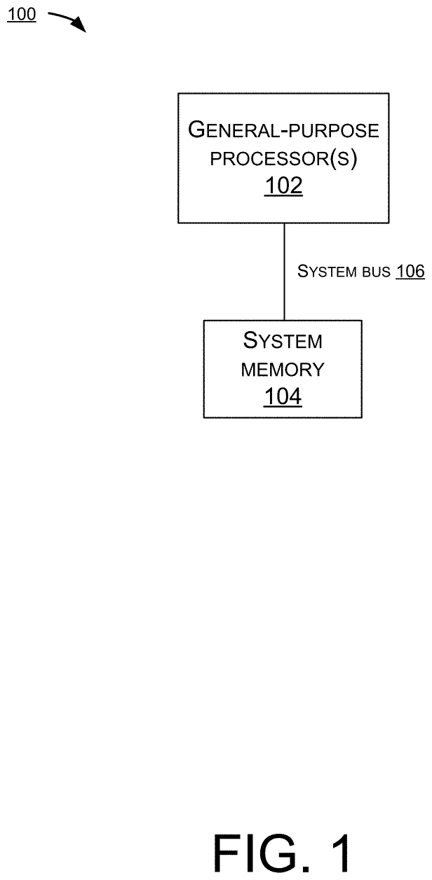

According to example embodiments of the present disclosure, it should be understood that it is desired to configure a computing system (as shall be described in more detail subsequently with reference to FIG. 1) to optimize one or more components of a function ƒ(x), subsequently referenced as an “objective function.” It should be further understood that the objective function ƒ(x) may be a black-box function, indicating that the nature of the objective function is not known; the computing system can only characterize the objective function by the computing system performing computations to evaluate outputs to the objective function corresponding to various possible inputs. Thus, the computing system may need to evaluate multiple outputs of the objective function in order to adequately characterize the objective function for the purpose of optimization. In particular, for such a black-box function, the derivative of the function cannot be obtained, in which case the objective function cannot be optimized by the process of gradient descent as known to persons skilled in the art.

Thus, broadly speaking, the “shape” of a black-box function cannot be readily ascertained except by repeated computation to evaluate multiple outputs of the black-box function, gradually determining the shape of the function point by individual point. However, with reference to objective functions according to example embodiments of the present disclosure, it is expected that they are continuous functions rather than discontinuous functions.

Moreover, it should be understood that the objective function ƒ(x) may be an expensive function, indicating that, at least for a computing system according to example embodiments of the present disclosure, the computing system incurs substantial computational costs in evaluating any output of the objective function ƒ(x). A computing system according to example embodiments of the present disclosure may be an individual or personal computing system; compared to distributed systems, cloud networks, data centers, and the like, such a computing system may have a comparatively low number of processors and/or cores per processor; may have relatively low memory resources; and may have relatively small storage space compared to the collective computing resources accessible in a distributed system, cloud network, data center, and the like. Thus, it is prohibitively expensive to repeatedly evaluate multiple outputs in order to determine the shape of an expensive black-box function.

FIG. 1 illustrates a system architecture of a system 100 configured to compute Bayesian optimization according to example embodiments of the present disclosure.

A system 100 according to example embodiments of the present disclosure may include one or more general-purpose processor(s) 102. The general-purpose processor(s) 102 may be physical or may be virtualized. The general-purpose processor(s) 102 may execute one or more instructions stored on a computer-readable storage medium as described below to cause the general-purpose processor(s) 102 to perform a variety of functions.

It should be understood that some systems according to example embodiments of the present disclosure may be additionally configured with one or more special-purpose processor(s), may be computing devices having hardware or software elements facilitating computation of neural network computing tasks such as training and inference computations, such as Graphics Processing Units (“GPUs”). Such special-purpose processor(s) may, for example, implement engines operative to compute mathematical operations such as matrix operations and vector operations. However, for the purpose of example embodiments of the present disclosure, a system 100 does not need to be configured with any special-purpose processor(s).

A system 100 may further include a system memory 104 communicatively coupled to the general-purpose processor(s) 102 by a system bus 106. The system memory 104 may be physical or may be virtualized. Depending on the exact configuration and type of the system 100, the system memory 104 may be volatile, such as RAM, non-volatile, such as ROM, flash memory, miniature hard drive, memory card, and the like, or some combination thereof. The system bus 106 may transport data between the general-purpose processor(s) 102 and the system memory 104.

According to example embodiments of the present disclosure, the configuration of a computing system to optimize one or more components of an objective function may be part of a larger process of configuring a computing system to run a machine learning model. In machine learning, a computing system may be configured to train a machine learning model on one or more sets of labeled samples. A machine learning model, once trained, may learn a set of parameters, such as an embedding of features in some number of dimensions which enable the model to compute unlabeled samples as input and estimate or predict one or more result(s) as output. For example, a trained machine learning model may be a classifier which learns a set of parameters which enable the classifier to classify unlabeled input as one of multiple class labels.

Thus, the black-box nature of the objective function ƒ(x) reflects the purpose of the computing system running a machine learning model to model and approximate some phenomenon, where the behavior of the phenomenon is unknown; by determining parameters of the learning model, the model may be trained to approach the behavior of the phenomenon as closely as possible. Among components of the objective function ƒ(x), the computing system may be configured to learn a component referred to as a loss function by iteratively tuning parameters of the loss function over epochs of the training process, as known to persons skilled in the art.

Other than a loss function, components of the objective function ƒ(x), may further include a hyperparameter (which may itself include any number of components, or the objective function may include multiple hyperparameters; thus, for the purpose of understanding the present disclosure, it should be understood that the use of the singular “hyperparameter” does not preclude multiple hyperparameters, or a hyperparameter including multiple components). Distinct from parameters, a computing system does not learn a hyperparameter while training a learning model. Instead, a computing system configured to run a machine learning model may determine a hyperparameter outside of training the learning model. In this manner, a hyperparameter may reflect intrinsic characteristics of the learning model which will not be learned, or which will determine performance of the computing system during the learning process.

Thus, optimizing a loss function component of an objective function may refer to the process of training the machine learning model, while optimizing a hyperparameter of an objective function may refer to the process of determining a hyperparameter before training the machine learning model, by an additional optimization computation.

Due to the objective function being expensive, the computing system may be configured to optimize a hyperparameter of an objective function by optimizing an acquisition function as a surrogate for the objective function, as shall be described subsequently.

The computing system may be configured to optimize a hyperparameter of an objective function by selecting a prior distribution of the objective function. A prior distribution refers to a statistical distribution along which outputs of the objective function are expected to fall. Such statistical distributions may be linear distributions; for example, a “Gaussian prior” of the objective function refers to an expectation that outputs of the objective function will fall along a Gaussian distribution. It should be understand that the space occupied by the Gaussian distribution depends upon a Gaussian kernel, which is defined by various kernel parameters as known to persons skilled in the art.

Furthermore, the computing system may be configured to optimize a hyperparameter of an objective function by sampling several outputs of the objective function, and updating the prior distribution to derive a posterior distribution. Since the objective function is expensive, the computing system generally cannot evaluate more than a few outputs of the objective function. Thus, the computing system is further configured to, based on these few sampled outputs, update the Gaussian kernel of the prior distribution in accordance with regression methods as known to persons skilled in the art, causing the distribution to describe the sampled outputs more accurately. After some iterations of regression, the updated prior distribution may be characterized as a posterior distribution, which may describe expected outputs of the objective function more accurately than the prior distribution.

A regression model, according to example embodiments of the present disclosure, may be a set of equations fitted to observations of values of variables. A regression model may be computed based on observed data. A computed regression model may be utilized to approximate non-observed values of variables which are part of the regression model.

Updating the Gaussian kernel by regression generally proceeds according to Gaussian Process (“GP”) regression, wherein a covariance matrix represents the Gaussian prior distribution, and coefficients of the covariance matrix represent the Gaussian kernel. The process of a computing system performing GP regression is generally known to persons skilled in the art and need not be described in detail herein, except to say that the computing system will need to compute a matrix inversion upon the covariance matrix; this is generally the most computationally intensive step of GP regression, since, for a covariance matrix of size n×n, computational complexity of an inversion operation upon the matrix is O(n³), according to conventional implementations of GP regression by linear algebra.

Furthermore, the computing system may be configured to sample each output of the objective function based on an acquisition function. An acquisition function is a function, derived from the prior distribution, for which the computing system may evaluate outputs with a lower computational cost than the objective function. Furthermore, an acquisition function is expected to be optimized at similar points x for which the objective function would also be optimized, based on previous sampled outputs of the objective function. Moreover, it should be understood that the wording “an acquisition function” does not limit example embodiments of the present disclosure to a single acquisition function; multiple acquisition functions may be derived from the prior distribution and optimized for a same objective function, for improved surrogacy emphasizing several different measures. Examples of acquisition functions include probability of improvement (“PI”), expected improvement (“EI”), upper confidence bounce (“UCB”), lower confidence bounce (“LCB”), and any other suitable acquisition function as known to persons skilled in the art.

To select each x for which an output of ƒ(x) is to be sampled, the computing system determines an optimal output of an acquisition function, and, for that corresponding input x, samples ƒ(x) as a basis for updating the Gaussian kernel of the prior distribution by regression.

It should be understood that such sequences of computations as described above, wherein the computing system optimizes an acquisition function to determine an input x; sample an output of the objective function for input x; and update the Gaussian kernel of the prior distribution by regression may be performed in multiple iterations, one after another. Due to the objective function being expensive to compute, it should be understood that among steps of Bayesian optimization performed by a computing system, these above-listed sequences of computations may be the most computationally intensive and most high-cost. Subsequently, according to the present disclosure, each performance of the above-listed steps by a computing system may be referenced as an “optimization iteration,” for brevity.

Summarizing the above-described process, a hyperparameter may be optimized by configuring the computing system to perform Bayesian optimization upon an objective function. In manners as known to persons skilled in the art, a computing system may be configured by a set of computer-readable instructions written using the BayesOpt programming library; the SigOpt programming library; the BoTorch programming library; the TuRBO programming library; the GPyTorch programming library; and other such programming libraries providing application programming interfaces (“APIs”) which configure a computing system to run a set of computer-readable instructions which carry out computations relating to Bayesian optimization as known to persons skilled in the art, as described above.

However, these known programming libraries generally suffer shortcomings. By way of example, both BayesOpt and BoTorch provide APIs which configure a computing system to perform each optimization iteration by newly allocating computing resources for computing steps of each optimization iteration. For example, the APIs may configure the computing system to newly allocate memory wherein steps of each optimization iteration are executed. Moreover, the APIs may configure the computing system to perform steps of each optimization iteration independently, without context of any previous optimization iteration. Consequently, the computing system may incur compounding computational costs for every additional optimization iteration performed, since every optimization iteration has approximately similar costs as every other optimization iteration.

In part, this compounding computational cost may be ascribed to programming libraries such as BayesOpt and BoTorch incorporating standard open-source programming modules for mathematical computations as known to persons skilled in the art, these programming libraries configure computing systems to incur the additional computational costs of each of these programming modules in turn.

Moreover, programming libraries such as BoTorch implement a matrix inversion upon the covariance matrix in a computationally intensive manner, according to conventional implementations of GP regression by linear algebra, wherein for a covariance matrix of size n×n, computational complexity of an inversion operation upon the matrix is O(n³).

Additionally, programming libraries such as BoTorch, over and above other implementations of Bayesian optimization, further implement differentiating the derivative of acquisition functions, providing more information for the Bayesian optimization process; however, such implementations are based on programming modules, such as Autograd, which configure a computing system to perform matrix arithmetic operations. As benchmarked according to various implementations of Autograd, such matrix arithmetic operations, while computed comparatively efficiently by special-purpose processor(s) as described above, are computed much less efficiently by general-purpose processor(s). Thus, implementations of Bayesian optimization based on gradient differentiation, as known to persons skilled in the art, tend not to configure a computing system having only general-purpose processor(s), or a computing system configured to perform computation tasks primarily on general-purpose processor(s), to perform efficiently.

Consequently, example embodiments of the present disclosure provide a set of Bayesian optimization computation modules, which configure a computing system to execute computer-readable instructions making up each module. Although each module may have one or more logical dependencies with one or more other modules, these inter-module logical dependencies are kept to a minimum.

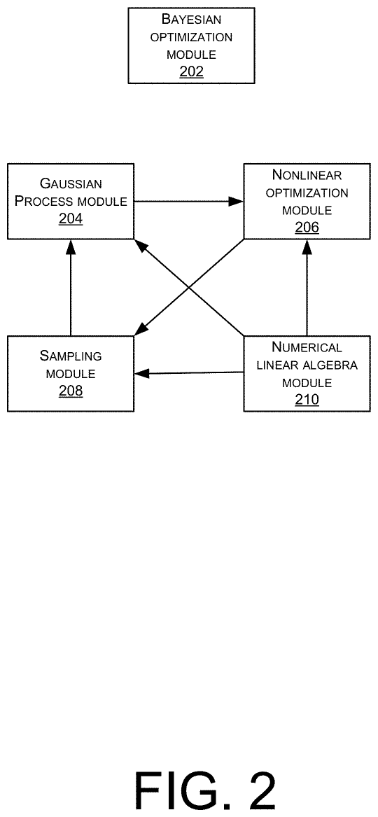

FIG. 2 illustrates Bayesian optimization computation modules according to example embodiments of the present disclosure. The modules include a Bayesian optimization module 202; a Gaussian Process module 204; a nonlinear optimization module 206; a sampling module 208; and a numerical linear algebra module 210. Each of these modules may configure a computing system to perform steps as described subsequently.

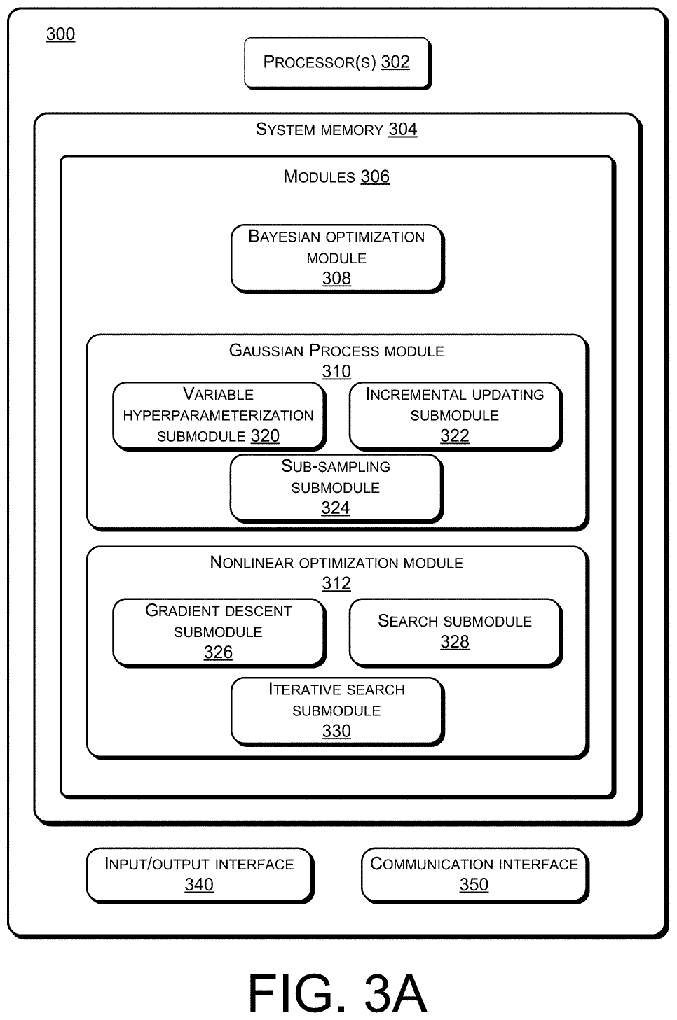

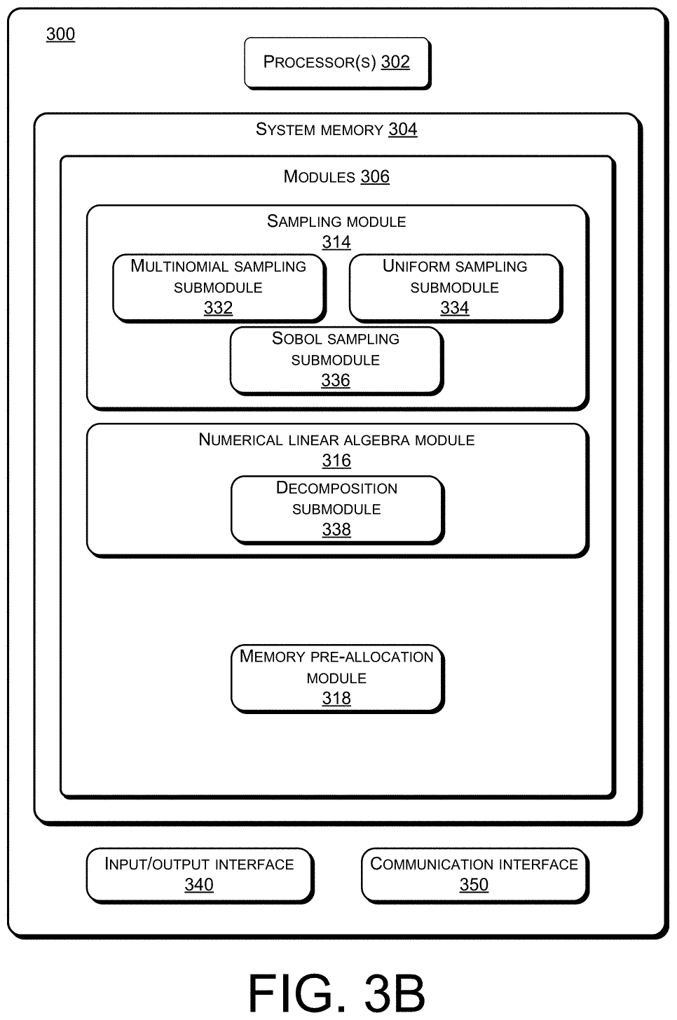

The Bayesian optimization module 202 may include computer-readable instructions stored on a computer-readable storage medium (as described subsequently with reference to FIGS. 3A and 3B) which configure the computing system to display an interactive interface on an output interface, and receive inputs over an input interface, the interactive interface being operable by users of the computing system to operate the computing system to collect data, organize data, set parameters, and perform the Bayesian optimization process as described herein.

The Gaussian Process module 204 may include computer-readable instructions stored on a computer-readable storage medium (as described subsequently with reference to FIGS. 3A and 3B) which configure the computing system to perform GP regression. The Gaussian Process module 204 may include computer-readable instructions stored on a computer-readable storage medium which configure the computing system to estimate kernel hyperparameters of an updated prior distribution based on a sampled output of an objective function. Thus, the Gaussian Process module 204 may have a dependency from the sampling module 208, as shall be described subsequently.

The nonlinear optimization module 206 may include computer-readable instructions stored on a computer-readable storage medium (as described subsequently with reference to FIGS. 3A and 3B) which configure the computing system to perform an optimization computation based on a posterior distribution. According to some example embodiments of the present disclosure, the nonlinear optimization module 206 may include computer-readable instructions stored on a computer-readable storage medium which configure the computing system to perform a gradient descent computation. Since the posterior distribution may be differentiable and is expected to describe expected outputs of the objective function with some degree of accuracy, the computing system may be configured to differentiate the posterior distribution as a surrogate for the objective function.

For example, the computing system may be configured to perform a gradient descent computation by various implementations which are comparatively efficient when executed by general-purpose processor(s) compared to special-purpose processor(s). That is, such implementations, while ultimately relying upon matrix arithmetic operations to some extent, and while ultimately declining in performance to some extent during execution by a general-purpose processor (compared to a special-purpose processor), do not call matrix arithmetic operation functions (thus creating dependencies with the numerical linear algebra module 210, as described subsequently) to an extent that general-purpose processor(s) substantially decline in performance efficiency. Such implementations, according to example embodiments of the present disclosure, include Adam, and limited-memory Broyden-Fletcher-Goldfarb-Shannon (“L-BFGS”).

For example, some of the above implementations of gradient descent may avert substantial declines in performance efficiency by, instead of performing differentiation on a full matrix representation of the posterior distribution, performing differentiation on an approximation of the posterior distribution by multiple vectors. Thus, these implementations of gradient descent may substantially improve performance on general-purpose processor(s), over matrix arithmetic-heavy implementations such as Autograd.

According to some example embodiments of the present disclosure, the nonlinear optimization module 206 may include computer-readable instructions stored on a computer-readable storage medium which do not configure the computing system to perform a gradient descent computation. Since differentiating the posterior distribution may still ultimately depend upon matrix arithmetic operations to some extent, instead of differentiating the posterior distribution as a surrogate for the objective function, instead a computing system may be configured to determine a maximum or minimum of the posterior distribution by other methods.

For example, the computing system may be configured to perform global and local searches over the posterior distribution to determine a maximum or minimum, according to implementations of DIviding RECTangles (“DIRECT”) optimization. Such implementations may be comparatively efficient when executed by general-purpose processor(s) compared to special-purpose processor(s), as they generally do not search the entire posterior distribution, but rather begin from constrained local searches before expanding to global searches.

Furthermore, the computing system may be configured to iteratively search linear approximations of the posterior distribution to determine a maximum or minimum, according to implementations of Constrained Optimization by Linear Approximations (“COBYLA”). Such implementations may be comparatively efficient when executed by general-purpose processor(s) compared to special-purpose processor(s), as they do not search the entire posterior distribution, but rather search linear approximations of the posterior distribution in iterations to identify a maximum or minimum each time.

Furthermore, each such implementation of nonlinear optimization as described above, whether configuring the computing system to perform a gradient descent computation or not, may configure the computing system to consume decreased memory resources compared to performing a gradient descent computation upon a full matrix representation of the posterior distribution (such as according to implementations of Autograd), by configuring the computing system to perform operations upon one or more simplified representations of the posterior distribution. In this manner, each such implementation of nonlinear-optimization may be referred to as a “reduced-memory” implementation of nonlinear optimization.

During each optimization iteration according to example embodiments of the present disclosure, the computing system may be configured to combine one or more implementations of nonlinear optimization as described above. For example, the computing system may be configured to apply DIRECT optimization upon a posterior distribution to partially derive a minimum or maximum, such as deriving a subset of the posterior distribution as a possible range; and then to apply L-BFGS upon the subset to narrow down an optimal minimum or maximum.

Since the optimization computation is performed using a posterior distribution, the nonlinear optimization module 206 may have a dependency from the Gaussian Process module 204.

The sampling module 208 may include computer-readable instructions stored on a computer-readable storage medium (as described subsequently with reference to FIGS. 3A and 3B) which configure the computing system to sample outputs of an objective function. For example, the sampling module 208 may include computer-readable instructions stored on a computer-readable storage medium which configure the computing system to evaluate the objective function at inputs x₁, x₂, . . . , xₙ, where x₁, x₂, . . . , xₙ are randomly selected according to a multinomial distribution; or where x₁, x₂, . . . , xₙ are randomly selected according to a uniform distribution; or where x₁, x₂, . . . , xₙ are randomly selected according to a Sobol sequence.

The sampling module 208 may configure the computing system to evaluate the objective function ƒ(x) for each input x₁, x₂, . . . , xₙ, as described above as part of an optimization iteration as described above. Thus, the computational work performed by the computing system as configured by the sampling module 208 may be particularly intensive.

The numerical linear algebra module 210 may include computer-readable instructions stored on a computer-readable storage medium (as described subsequently with reference to FIGS. 3A and 3B) which configure the computing system to perform matrix arithmetic computations. For example, the numerical linear algebra module 210 may include computer-readable instructions stored on a computer-readable storage medium which configure the computing system to perform matrix decomposition.

The computing system may be configured to perform matrix decomposition to decompose a linear matrix, such as a covariance matrix of a Gaussian prior distribution. As described above, a computing system performing matrix inversion upon the covariance matrix, being O(n³) in computational complexity, may be intractably computationally intensive for large covariance matrices. Thus, configuring the computing system to decompose the covariance matrix may yield several smaller, decomposed matrices, such that individually inverting each of these decomposed matrices may be less computationally intensive than inverting the covariance matrix.

Matrix inversion being potentially a step of any of the other computational modules as described above, the numerical linear algebra module 210 may have a dependency from the Gaussian Process module 204, may have a dependency from the nonlinear optimization module 206, and may have a dependency from the sampling module 208.

Additionally, the computing system may be configured to perform any other matrix arithmetic operation as known to persons skilled in the art. Since each of the other modules may invoke function calls for performance of matrix arithmetic operations, the numerical linear algebra module 210 may have a dependency from any of the above-mentioned modules.

According to example embodiments of the present disclosure, according to the Bayesian optimization computation modules as described above, the computing system may be configured to execute each module in a fashion which does not change depending upon implementation of each other module. Thus, the functionality of each module may be extended without altering its relationship to or dependencies from other modules; for example, the nonlinear optimization module 206 may configure the computing system to perform any implementation of nonlinear optimization, or any combination of implementations of nonlinear optimization, without altering the Gaussian Process module 204, despite the dependency from the nonlinear optimization module 206 to the Gaussian Process module 204. The sampling module 208 may configure the computing system to evaluate the objective function at inputs according to any distributions as described above, without altering the Gaussian Process module 204, despite the dependency from the sampling module 208 to the Gaussian Process module 204. The numerical linear algebra module 210 may configure the computing system to perform any variety of matrix arithmetic operations, including expanding the number of matrix arithmetic operations configured and improving efficiency of matrix arithmetic operations configured, without altering any of the other modules, despite dependencies from the numerical linear algebra module 210 to each of the other modules.

For example, according to example embodiments of the present disclosure, the above-described Bayesian optimization computation modules may be improved in functionality in at least the below respects.

The Gaussian Process module 204, according to example embodiments of the present disclosure, may configure a computing system to perform updates upon a Gaussian kernel which includes one or more of a Matérn kernel and a radial basis function (“RBF”) kernel, as well as a scale factor. The Gaussian kernel, according to example embodiments of the present disclosure, may have variable hyperparameterization, as shall be described subsequently.

During earlier optimization iterations of a Bayesian optimization process as described above, the computing system has sampled comparatively few outputs of the objective function, relative to later optimization iterations; thus, during earlier optimization iterations, updates to the Gaussian kernel in accordance with regression methods may risk overfitting the Gaussian kernel to sparse observational data. Thus, the Gaussian kernel may be variably hyperparameterized such that the Gaussian kernel function includes one hyperparameter during a first optimization iteration, as well as each subsequent optimization iteration until sampled outputs of the objective function exceed a sample threshold. The threshold may be, for example, the number of variables of the objective function. Thus, during optimization iterations after sampled outputs of the objective function exceed a sample threshold, the Gaussian kernel function may include multiple hyperparameters, up to full hyperparameterization of one hyperparameter for each variable of the objective function.

In this fashion, during earlier optimization iterations, the Gaussian Process module 204 may configure the computing system to update only one hyperparameter of the Gaussian kernel, and during later optimization iterations, whereupon more sampled outputs have been observed (since it is computationally costly to observe each sampled output), the Gaussian Process module 204 may configure the computing system to update each hyperparameter of the Gaussian kernel. Such variable hyperparameterization reduces computational costs of the earlier optimization iterations, while also averting overfitting and destabilization of the Gaussian kernel during optimization iterations where the objective function has only been sparsely observed.

Furthermore, as the computing system adds sampled outputs to the set of sampled outputs, it should be noted that computational complexity of updating the Gaussian kernel is generally the cube of the size of the set of sampled outputs. Thus, to avert the computational cost of each optimization iteration from compounding in this fashion, the Gaussian Process module 204, according to example embodiments of the present disclosure, may configure a computing system to simplify updating the Gaussian kernel in one or more of the below manners.

For example, the Gaussian Process module 204 may configure the computing system to incrementally update the Gaussian kernel: that is, during at least some optimization iterations, the computing system may be configured to update the Gaussian kernel by recording an update to each hyperparameter of the Gaussian kernel as a relative difference to a previous hyperparameter iteration, rather than as a newly computed hyperparameter. In this fashion, the Gaussian Process module 204 may configure the computing system to reduce computational complexity of updating the Gaussian kernel to the square of the size of the set of sampled outputs, by deferring computing updates to each hyperparameter while the optimization iterations are ongoing.

Additionally, the Gaussian Process module 204 may configure the computing system to sub-sample the sampled outputs of the objective function: that is, in the event that the objective function has a large number of variables, and upon the set of sampled outputs exceeding a size threshold (where the size threshold may indicate that, in practice, computational complexity of updating the Gaussian kernel based on the set of sampled outputs may become intractable on a general-purpose processor), the computing system may alleviate the computational complexity of updating the Gaussian kernel by sampling a subset of the set of sampled outputs, discarding the non-sampled outputs, and updating the Gaussian kernel based on the sampled subset. For example, the Gaussian Process module 204 may configure the computing system to sample the subset according to a uniform distribution across the set of sampled outputs. In this fashion, the Gaussian Process module 204 may configure the computing system to further reduce computational complexity of updating the Gaussian kernel.

Moreover, according to example embodiments of the present disclosure, according to the Bayesian optimization computation modules as described above, the computing system may be configured to pre-allocate memory for each module before optimization iterations begin, in order to avoid releasing and re-allocating memory between each optimization iteration. According to conventional implementations of Bayesian optimization as described above, memory would be released and re-allocated between each iteration of the optimization process. According to example embodiments of the present disclosure, one or more of the Bayesian optimization computation modules may configure a computing system to determine a memory upper bound before starting to perform optimization iterations. The computing system may be configured to determine the memory upper bound in relation to an upper bound of points of the objective function which the computing system may sample during the optimization iterations. Based on memory space which a nonlinear optimization module 206 configures a computing system to consume for various data structures used in updating a Gaussian kernel (which may be reduced in accordance with one or more reduced-memory implementations, as described above); memory space which a sampling module 208 configures the computing system to consume per sampled output, multiplied by the upper bound of points; and memory space which a numerical linear algebra module 210 may consume for various data structures used during computation of matrix arithmetic operations (which may be reduced in accordance with, for example, matrix decomposition as described above), the Bayesian optimization computation modules may collectively configure the computing system to determine a memory upper bound, and pre-allocate working memory, before any optimization iteration begins, sized in accordance with the memory upper bound. The computing system may be configured to reuse this working memory during each optimization iteration, without releasing the working memory until at least completing a final optimization iteration.

In this fashion, the computing system may be configured to avert repeated allocation and release of memory, repeated writing of data in memory to non-volatile storage, and repeated reading of data in non-volatile storage to memory across multiple optimization iterations, thereby alleviating multiple categories of computing resources, including processing power, memory, storage, from excess performance load.

It should be understood that within this working memory reused across optimization iterations, matrices may be stored as data structures, and any matrix stored in the working memory may have one or more columns or rows stored discontinuously from other columns and/or rows of the same matrix. Consequently, according to example embodiments of the present disclosure, the numerical linear algebra module 210 may further configure the computing system to perform matrix arithmetic operations, such as matrix addition and matrix multiplication; matrix decomposition; and solving linear equations based on one or more data structures stored in non-continuous regions of working memory.

FIGS. 3A and 3B illustrate an example computing system 300 for implementing the processes and methods described above for implementing Bayesian optimization.

The techniques and mechanisms described herein may be implemented by multiple instances of the computing system 300, as well as by any other computing device, system, and/or environment, but may be implemented by only one instance of the computing system 300. The computing system 300, as described above, may be any varieties of computing devices, such as personal computers, personal tablets, mobile devices, other such computing devices operative to perform (but not necessarily specialized for performing) matrix arithmetic computations. The computing system 300 shown in FIGS. 3A and 3B is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The computing system 300 may include one or more processors 302 and system memory 304 communicatively coupled to the processor(s) 302. The processor(s) 302 and system memory 304 may be physical or may be virtualized. The processor(s) 302 may execute one or more modules and/or processes to cause the processor(s) 302 to perform a variety of functions. In embodiments, the processor(s) 302 may include a central processing unit (“CPU”), a GPU, or other processing units or components known in the art, though a GPU need not necessarily perform any steps according to example embodiments of the present disclosure. Additionally, each of the processor(s) 302 may possess its own local memory, which also may store program modules, program data, and/or one or more operating systems.

Depending on the exact configuration and type of the computing system 300, the system memory 304 may be volatile, such as RAM, non-volatile, such as ROM, flash memory, miniature hard drive, memory card, and the like, or some combination thereof. The system memory 304 may include one or more computer-executable modules 306 that are executable by the processor(s) 302.

The modules 306 may include, but are not limited to, a Bayesian optimization module 308, a Gaussian Process module 310, a nonlinear optimization module 312, a sampling module 314, a numerical linear algebra module 316, and a memory pre-allocation module 318.

The Bayesian optimization module 308 may configure the computing system 300 to display an interactive interface on an output interface, and receive inputs over an input interface as described above with reference to FIG. 2.

The Gaussian Process module 310 may configure the computing system to perform GP regression as described above with reference to FIG. 2.

The nonlinear optimization module 312 may configure the computing system to perform an optimization computation based on a posterior distribution as described above with reference to FIG. 2.

The sampling module 314 may configure the computing system to sample outputs of an objective function as described above with reference to FIG. 2.

The numerical linear algebra module 316 may configure the computing system to perform matrix arithmetic computations as described above with reference to FIG. 2.

The memory pre-allocation module 318 may configure the computing system to determine a memory upper bound and pre-allocate working memory as described above.

The Gaussian Process module 310 may further include a variable hyperparameterization submodule 320 which may configure the computing system to perform variable hyperparameterization as described above.

The Gaussian Process module 310 may further include an incremental updating submodule 322 which may configure the computing system to incrementally update the Gaussian kernel as described above.

The Gaussian Process module 310 may further include a sub-sampling submodule 324 which may configure the computing system to sub-sample the sampled outputs of the objective function as described above.

The nonlinear optimization module 312 may further include a gradient descent submodule 326 which may configure the computing system to perform a gradient descent computation as described above with reference Adam and/or L-BFGS.

The nonlinear optimization module 312 may further include a search submodule 328 which may configure the computing system to perform global and local searches over a posterior distribution as described above with reference to DIRECT optimization.

The nonlinear optimization module 312 may further include an iterative search submodule 330 which may configure the computing system to iteratively search linear approximations of the posterior distribution as described above with reference to COBYLA.

The sampling module 314 may further include a multinomial sampling submodule 332 which may configure the computing system to sample outputs of an objective function according to a multinomial distribution as described above with reference to FIG. 2.

The sampling module 314 may further include a uniform sampling submodule 334 which may configure the computing system to sample outputs of an objective function according to a uniform distribution as described above with reference to FIG. 2.

The sampling module 314 may further include a Sobol sampling submodule 336 which may configure the computing system to sample outputs of an objective function according to a Sobol sequence as described above with reference to FIG. 2.

The numerical linear algebra module 316 may further include a decomposition submodule 338 which may configure the computing system to perform matrix decomposition as described above with reference to FIG. 2.

The computing system 300 may additionally include an input/output (“I/O”) interface 340 and a communication module 350 allowing the computing system 300 to communicate with other systems and devices over a network. The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1 and 2. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Performance of Bayesian optimization according to example embodiments of the present disclosure (subsequently designated as “Example” for short) is measured against the BayesOpt and BoTorch programming libraries, as described above. For these experiments, the objective function was the Levy function, a test function as known to persons skilled in the art; the function has several local minima, and a global minimum of 0. (Subsequently, “Levy 5” designates the Levy function having five variables; “Levy 10” designates the Levy function having 10 variables; and so on.) Each of the Bayesian optimization implementations was run using the Levy function as a black-box objective function, on a personal computer having a 2.3 GHz processor and 8 GB of internal memory.

Table 1 illustrates performance comparisons against BayesOpt. The Example was configured such that the acquisition function was EI; the nonlinear optimization process used was DIRECT followed by COBYLA, where the Gaussian kernel is furthermore incrementally updated.

| | | Number of | Total |
|---|---|---|---|
| | Function | optimization | running |
| | evaluated | iterations | time(s.) |
| BayesOpt | Levy 5 | 100 | 31.6916 |
| Example | | 100 | 1.4168 |
| BayesOpt | Levy 10 | 100 | 240.733 |
| Example | | 100 | 8.66142 |
| BayesOpt | Levy 20 | 60 | 383.112 |
| Example | | 60 | 25.4375 |
| Example | | 100 | 62.9572 |

It may be seen that in each direct comparison under the same conditions, the Example was over 10 times more efficient in computation speed than BayesOpt.

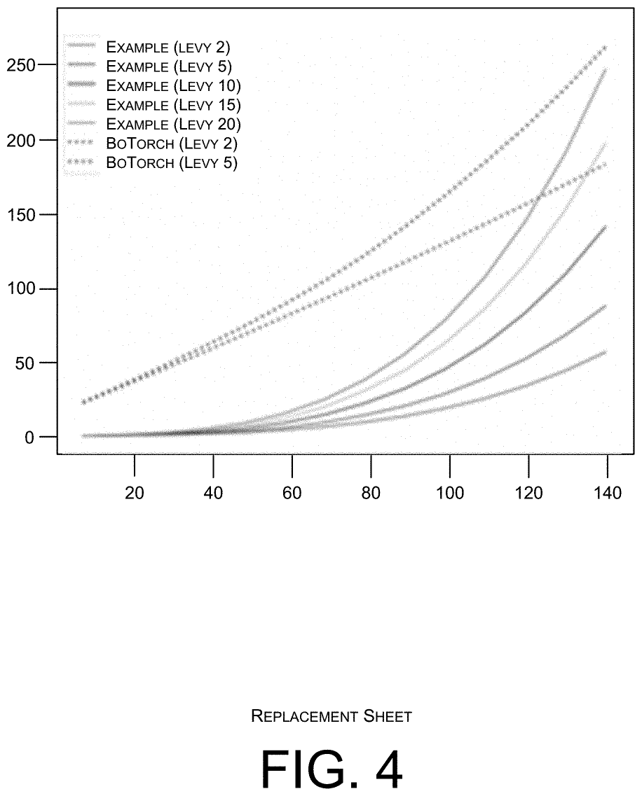

FIG. 4 illustrates performance comparisons against BoTorch. The Example was configured such that the acquisition function was a modified constrained expected improvement function (“mCEI”); the nonlinear optimization processed used was Adam; and sampling was performed according to both uniform distribution and multinomial distribution. All solid lines illustrated represent BoTorch performance, and all broken lines illustrated represent Example performance.

It may be seen that in each direct comparison under the same conditions, the Example was over 3 times more efficient in computation speed than BoTorch. Furthermore, BoTorch only exceeds the Example in efficiency for large numbers of optimization iterations (in excess of 100).

Thus, performance improvements over conventional Bayesian optimization implementations are achieved by implementing example embodiments of the present disclosure, enabling experimenters and researchers having access to only low-cost, personal computers to perform Bayesian optimization as part of machine learning without incurring high computational costs and low efficiency.

By the abovementioned technical solutions, the present disclosure provides implementing a modular computing environment for Bayesian optimization, decoupling steps of Bayesian optimization across multiple modules; minimizing inter-module dependency; extending functionality of each module; and reusing computing resources and intermediate results within each module. Variable hyperparameterization may reduce computational costs of optimization iterations, while also averting overfitting and destabilization of the Gaussian kernel based on sparser observations of the objective function. Computational complexity of updating the Gaussian kernel may be reduced from the cube to the square of the set of sampled outputs, by deferring computing updates to each hyperparameter while the optimization iterations are ongoing. Furthermore, repeated allocation and release of memory, repeated writing of data in memory to non-volatile storage, and repeated reading of data in non-volatile storage to memory across multiple optimization iterations may be averted, thereby alleviating multiple categories of computing resources, including processing power, memory, storage, from excess performance load.

### Example Clauses

A. A method comprising: pre-allocating, by a computing system, working memory; and performing, by the computing system, a plurality of iterations of the following steps within the working memory: optimizing, by the computing system, an acquisition function based on a distribution; sampling, by the computing system, an output of an objective function; and updating, by the computing system, a kernel of the distribution by regression.

B. The method as paragraph A recites, wherein the computing system optimizes the acquisition function by performing a gradient descent computation over the distribution.

C. The method as paragraph A recites, wherein the computing system optimizes the acquisition function by performing global and local searches over the distribution.

D. The method as paragraph A recites, wherein the computing system optimizes the acquisition function by iteratively searching linear approximations of the distribution.

E. The method as paragraph A recites, wherein the computing system updates the kernel of the distribution by performing variable hyperparameterization.

F. The method as paragraph A recites, wherein the computing system updates the kernel of the distribution by incremental updates.

G. The method as paragraph A recites, wherein the computing system updates the kernel of the distribution by sub-sampling sampled outputs of the objective function.

H. A system comprising: one or more processors; and memory communicatively coupled to the one or more processors, the memory storing computer-executable modules executable by the one or more processors that, when executed by the one or more processors, perform associated operations, the computer-executable modules comprising: a memory pre-allocation module configuring the one or more processors to pre-allocate working memory; and a nonlinear optimization module, a sampling module, and a Gaussian Process module, respectively configuring the one or more processors to perform a plurality of iterations of the following steps within the working memory: optimize an acquisition function based on a distribution; sample an output of an objective function; and update a kernel of the distribution by regression.

I. The system as paragraph H recites, wherein the nonlinear optimizing module further comprises a gradient descent submodule configuring the one or more processors to optimize the acquisition function by performing a gradient descent computation.

J. The system as paragraph H recites, wherein the nonlinear optimizing module further comprises a search submodule configuring the one or more processors to optimize the acquisition function by performing global and local searches over the distribution.

K. The system as paragraph H recites, wherein the nonlinear optimizing module further comprises an iterative search submodule configuring the one or more processors to optimize the acquisition function by iteratively searching linear approximations of the distribution.

L. The system as paragraph H recites, wherein the Gaussian Process module further comprises a variable hyperparameterization submodule configuring the one or more processors to update the kernel of the distribution by performing variable hyperparameterization.

M. The system as paragraph H recites, wherein the Gaussian Process module further comprises an incremental updating submodule configuring the one or more processors to update the kernel of the distribution by incremental updates.

N. The system as paragraph H recites, wherein the Gaussian Process module further comprises a sub-sampling submodule configuring the one or more processors to update the kernel of the distribution by sub-sampling sampled outputs of the objective function.

O. A computer-readable storage medium storing computer-readable instructions executable by one or more processors, that when executed by the one or more processors, cause the one or more processors to perform operations comprising: pre-allocating, by a computing system, working memory; and performing, by the computing system, a plurality of iterations of the following steps within the working memory: optimizing, by the computing system, an acquisition function based on a distribution; sampling, by the computing system, an output of an objective function; and updating, by the computing system, a Gaussian kernel of the distribution by regression.

P. The computer-readable storage medium as paragraph O recites, wherein the computing system optimizes the acquisition function by performing a gradient descent computation over the distribution.

Q. The computer-readable storage medium as paragraph O recites, wherein the computing system optimizes the acquisition function by performing global and local searches over the distribution.

R. The computer-readable storage medium as paragraph O recites, wherein the computing system optimizes the acquisition function by iteratively searching linear approximations of the distribution.

S. The computer-readable storage medium as paragraph O recites, wherein the computing system updates the kernel of the distribution by performing variable hyperparameterization.

T. The computer-readable storage medium as paragraph O recites, wherein the computing system updates the kernel of the distribution by incremental updates.

U. The computer-readable storage medium as paragraph O recites, wherein the computing system updates the kernel of the distribution by sub-sampling sampled outputs of the objective function.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
pre-allocating, by a computing system, working memory; and
performing, by the computing system, a plurality of iterations of the following steps within the working memory:
optimizing, by the computing system, an acquisition function based on a distribution;
sampling, by the computing system, an output of an objective function; and
updating, by the computing system, a Gaussian kernel of the distribution by regression.

2. The method of claim 1, wherein the computing system optimizes the acquisition function by performing a gradient descent computation over the distribution.

3. The method of claim 1, wherein the computing system optimizes the acquisition function by performing global and local searches over the distribution.

4. The method of claim 1, wherein the computing system optimizes the acquisition function by iteratively searching linear approximations of the distribution.

5. The method of claim 1, wherein the computing system updates the kernel of the distribution by performing variable hyperparameterization.

6. The method of claim 1, wherein the computing system updates the kernel of the distribution by incremental updates.

7. The method of claim 1, wherein the computing system updates the kernel of the distribution by sub-sampling sampled outputs of the objective function.

8. A system comprising:
one or more processors; and
memory communicatively coupled to the one or more processors, the memory storing computer-executable modules executable by the one or more processors that, when executed by the one or more processors, perform associated operations, the computer-executable modules comprising:
a memory pre-allocation module configuring the one or more processors to pre-allocate working memory; and
a nonlinear optimization module, a sampling module, and a Gaussian Process module, respectively configuring the one or more processors to perform a plurality of iterations of the following steps within the working memory:
optimize an acquisition function based on a distribution;
sample an output of an objective function; and
update a kernel of the distribution by regression.

9. The system of claim 8, wherein the nonlinear optimizing module further comprises a gradient descent submodule configuring the one or more processors to optimize the acquisition function by performing a gradient descent computation.

10. The system of claim 8, wherein the nonlinear optimizing module further comprises a search submodule configuring the one or more processors to optimize the acquisition function by performing global and local searches over the distribution.

11. The system of claim 8, wherein the nonlinear optimizing module further comprises an iterative search submodule configuring the one or more processors to optimize the acquisition function by iteratively searching linear approximations of the distribution.

12. The system of claim 8, wherein the Gaussian Process module further comprises a variable hyperparameterization submodule configuring the one or more processors to update the kernel of the distribution by performing variable hyperparameterization.

13. The system of claim 8, wherein the Gaussian Process module further comprises an incremental updating submodule configuring the one or more processors to update the kernel of the distribution by incremental updates.

14. The system of claim 8, wherein the Gaussian Process module further comprises a sub-sampling submodule configuring the one or more processors to update the kernel of the distribution by sub-sampling sampled outputs of the objective function.

15. A computer-readable storage medium storing computer-readable instructions executable by one or more processors, that when executed by the one or more processors, cause the one or more processors to perform operations comprising:
pre-allocating, by a computing system, working memory; and
performing, by the computing system, a plurality of iterations of the following steps within the working memory:
optimizing, by the computing system, an acquisition function based on a distribution;
sampling, by the computing system, an output of an objective function; and
updating, by the computing system, a Gaussian kernel of the distribution by regression.

16. The computer-readable storage medium of claim 15, wherein the computing system optimizes the acquisition function by performing a gradient descent computation over the distribution.

17. The computer-readable storage medium of claim 15, wherein the computing system optimizes the acquisition function by performing global and local searches over the distribution.

18. The computer-readable storage medium of claim 15, wherein the computing system optimizes the acquisition function by iteratively searching linear approximations of the distribution.

19. The computer-readable storage medium of claim 15, wherein the computing system updates the kernel of the distribution by performing variable hyperparameterization.

20. The computer-readable storage medium of claim 15, wherein the computing system updates the kernel of the distribution by sub-sampling sampled outputs of the objective function.
